(19) United States
(12) Patent Application Publication
(10) Pub. No.: US 2006/0110023 A1
(43) Pub. Date: May 25, 2006

(54) Document validation device

(76) Inventors: Ronald J. Goetz, Freeport, IL (US); Kum K. Phang, Singapore (SG)

Correspondence Address: Kris T. Fredrick;Patent Services, Honeywell International Inc., 101 Columbia Road, Morristown, NJ, 07962, US

(21) Appl. No.: 10/997,380

(22) Filed: Nov. 24, 2004

(51) Int. Cl. G06K 9/00

(52) U.S. Cl. 382/139

(57) ABSTRACT

A device and method for validating a document having magnetic ink thereon after determining the existence of a document having magnetic ink thereon. The ink is magnetized and thereafter to a media reader sensor spaced from the document by a predetermined gap to verify the existence of a magnetic signal and rejecting documents without a magnetic signal. The magnetic signal is compared to a set of preexisting data to determine the existing of a signal to data match and validate only documents that have a match between the magnetic signal and pre-existing data. A set/reset sensor is preferably used to apply a signal to the magnetic ink on the document. A preferred predetermined gap is from about 0.25 mm to about 1.5 mm, and most preferred from about 0.5 mm to about 1.0 mm. Preferred comparators are microprocessors and preferred media reader sensors are anisotropic magnetoresistive sensors.

### FIELD OF THE INVENTION

The present invention relates in general to a device for sensing and reading magnetic ink in currency, bank notes and the like. More particularly, the present invention relates to a device in which a distinct and identifiable waveform in magnetic ink is read by a sensor that is spaced from the ink by an air gap.

### BACKGROUND OF THE INVENTION

Magnetic pattern sensors have been found to be suitable for differentiation of bank note types and patterns printed with magnetic ink. The typical applications include ATMs, cash counters, bill changers, ticket machines, automatic vending machines, card readers, and differentiation of E13B codes on gift certificates.

The broad applications of magnetic ink detection includes “credit card readers, cash dispensers, security, access control, phone-card and personnel logging, Standard cassette fittings, record/Playback magnetic heads, Bank Note Verification, Professional Audio, Film Stripes. By reading the magnetic stripes on credit and debit cards and driver's licenses—plus Magnetic Ink Character Recognition or MICR characters on checks, deposit and withdrawal slips, MICR readers speed transactions, eliminate manual entry errors and reduce fraud. Financial institutions use MICR check readers and magnetic card readers to optimize interaction with customers and to improve cost efficiencies. Hospitality and Gaming organizations rely on MICR check readers and credit card readers to provide easy connectivity to PC-based applications.

Creating a good magnetic ink reader is not without problems, however. The device is required to work with a large variety of bills from crisp new ones to ragged old ones, and it has to be reasonably good at telling real bills from counterfeit notes. In many cases the device also has to be able to sense the denomination of the bill. In order to accomplish the task, dollar bill changers use a variety of technologies. Many of the early bill changers took advantage of the fact that U.S. bills are printed with magnetic ink. By contrast, Euro bills are printed with magnetic material, which needs to be magnetized before sensing. Magnetic heads (like the ones in a cassette tape recorder) are used to pick up signals from the bills. Areas of the bill would generate signals at a specific frequency and the detection of this frequency would validate the bill. The wave form or pattern is time and amplitude based. Both are dependent on the feed mechanism in relationship to the magnetic ink. Changing the speed of the feed mechanism will result in a waveform change. The various technologies for detecting the magnetic ink include Inductive heads and MR heads. The MR heads has got advanced features over inductive heads like high sensitivity and compact in size and good resolution.

The detection of magnetic ink is a growing low-field magnetic sensor application. The use of iron oxide as a pigment in black ink has provided a method of reading and validating currency and other negotiable documents. Additional magnetic features are being added to currency as PCs and excellent quality color printers have moved counterfeiting from the realm of the skilled engraver. One such application is reading the Magnetic Ink Character Recognition or MICR characters on the bottom of checks.

The reading of currency is somewhat more difficult because the amount of magnetic ink is considerably less. The maximum field measured immediately above U.S. currency is less than 100 mOe or 8 A/m. Inductive read heads designed similarly to tape recorder heads need to be in direct contact to yield an adequate signal from US currency.

It would be a great advantage, to avoid jamming in high-speed transport mechanisms to be able to read the bill from a distance without contact, such as a few millimeters away.

Another advantage would be if a device could be provided that enhanced the magnetic properties of documents containing small amounts of magnetic materials such as iron oxide pigments to permit recognition and validation of the documents.

Yet another advantage would be if a device could be provided to read documents of various thicknesses without being calibrated or adjusted to account for a different thickness.

Other advantages and features will appear hereinafter.

The present invention provides a system for non-contact sensing and reading magnetic ink in documents. The term ‘document’ as used herein includes bank notes, currency, checks and any paper-like materials that contain iron oxide or other materials that can be magnetized. A document having at least a trace of magnitizable material is placed in the system in a predetermined pattern and a field is applied to magnetize the ink. The document is then “read” with a sensor capable of identifying the pattern. The read pattern is compared to a data base of patterns that have been installed to identify the different documents that are stored, and a decision is made as to whether the document pattern matches an approved pattern. In some embodiments, the device may be connected to other systems, such as recording payment, making change, crediting an account and the like. The essential feature of this invention is that the document passes over the sensor at a small gap or distance so that the document does not contact the sensor. This permits documents of varying thickness, age and condition, and other variables to be accepted without the danger of jamming, clogging or otherwise having the document disable the system. One critical advantage of using an air gap is that when the document is crumpled or folded, it may not be capable of being smoothed due to memory. Prior art devices will jam at some point beyond which it can not be reversed. The air gap of the present invention allows the reversal feature to be used at any point in the path of the document.

To achieve this goal, sensitive low-field sensors such as an Anisotropic Magnetoresistive (AMR) sensor or a Giant Magnetoresistive (GMR) sensors are utilized with amplification and filtering. The small size of AMR or GMR sensors offers the possibility of making closely spaced arrays of sensors to image a bill rather than just obtaining a signature on one line along or across the bill. Magnetic noise is common in the range of magnetic fields of interest to currency detection. Care must be taken to minimize the presence of moving magnetic materials in the transport mechanism. Fields from adjacent electronics and motors must be reduced. Differential sensors with a second sensor two to three times further from the bill can also be used to minimize the effect of magnetic noise.

The use of these sensors provides an opportunity to read the magnetized pattern at a distance. Preferred are devices where the gap is from about less than 0.25 mm to about more than 1.5 mm. Preferred are devices where the gap is from about 0.5 mm to about 1.0 mm. The essential feature is that there is a gap that is sufficient to space the document from the sensor and avoid jamming and the like but not so distant as to prevent the sensor from reading the pattern.

In once embodiment, the device simply reads the pattern and directly compares the read pattern to the library of stored patterns, then makes a determination of whether or not the comparison shows an acceptable document or not. In another embodiment, a circuit is provided to determine if the magnetized signal also contains noise. The device may then compensate for the noise, in one embodiment by use of a noise offset circuit. The signal is then read, amplified, and sent to the microprocessor to be compared to the data therein. When a document does not have the appropriate pattern for validation, it is rejected and the device is reset for the next document. The rejected document can either be discharged so as to return it to the user or the rejected document can be kept.

### BRIEF DESCRIPTION OF THE DRAWINGS

For a more complete understanding of the invention, reference is hereby made to the drawings, in which:

FIG. 1 is a block diagram showing one embodiment of the present invention; and

FIG. 2 is a block diagram showing another embodiment of the present invention.

In the figures, like reference characters designate identical or corresponding components and units throughout the several views.

### DETAILED DESCRIPTION OF THE PREFERRED EMBODIMENT

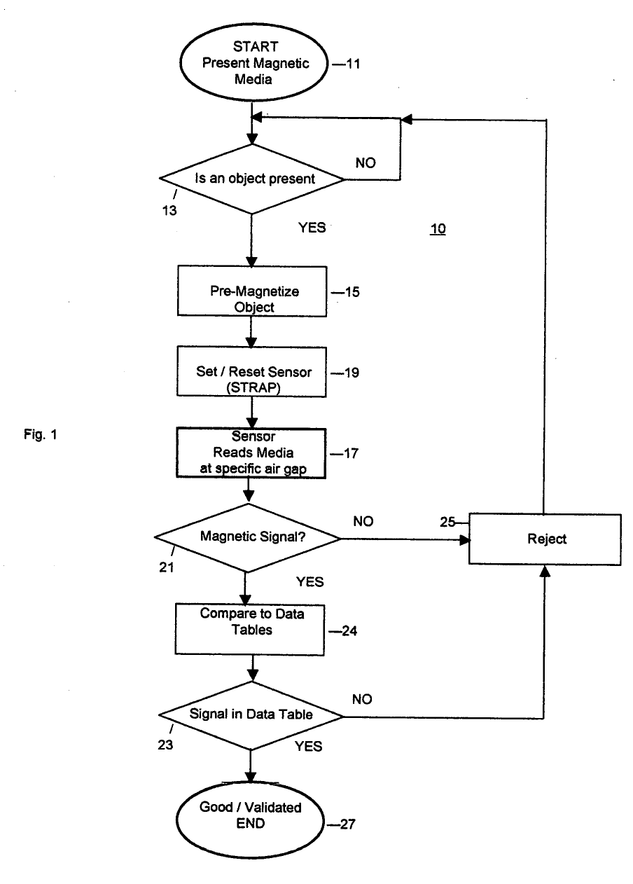

Referring to the figures, FIG. 1 shows the device 10, generally, where a bank note, currency bill or other document containing some ink or other material that can be magnetized, is inserted into the system at the start 11. The identifier 13 signals the presence of such a document and transfers it to a magnetizer station 15 where the iron oxide or other magnetizable material is subjected to a magnetic field and becomes magnetized. Sine the ink is in a predetermined and unique pattern for each different document, it will contain a magnetized version of that pattern. For example, a $1.00 U.S. bill will have a different pattern than a $5.00 or $100.00 bill. As will be described below, once the device magnetizes the ink, the sensor 17 is subjected to a set/reset function 19 to allow sensing of magnetic ink with greater sensitivity than previously attained. If a magnetic signal is detected by detector 21, the signal is compared by a comparator 23, usually a microprocessor, against data 24 stored in the comparator. If there is no signal at sensor 17 or if the signal from comparator 23 does not find a match in comparator 23, the document is rejected by a rejection device 25. Device 25 may return the document to the person attempting to have it verified or it can retain the document for later steps to be taken, depending on the nature of the document and the reason why it was rejected. In another embodiment, if a document is rejected and the data comparison indicates that the document may be counterfeit, a photograph of the user may be taken or an alarm (silent or otherwise) may alert a security detail. If the document is accepted, a validation device 27 completes the transaction, whatever that may be.

AMR sensors are known and are available from electronics manufacturers. Two preferred AMR sensors are manufactured by Honeywell International Inc. and sold under product designations HMC 1501 and HMC 1512. The HMC 1501 sensor contains one AMR bridge for a ±45° range of position sensing, and the HMC 1512 contains two AMR bridges for a ±90° range of position sensing. These sensors are fabricated with Permalloy (NiFe) thin films that create changes in resistivity with respect to external magnetic fields. These film materials are similar to magnetic recording tapes in that strong magnetic fields can disrupt the magnetic domains of the film particles from a smooth factory orientation to arbitrary directions. Accuracy and resolution of these sensors will suffer until the film magnetic domains are “reset” to recreate a uniform direction. This is overcome by use of a set and reset function for AMR sensors. Set or reset permits the sensor to recover from a strong external magnetic field that has re-magnetized the sensor or to optimize the magnetic domains for most sensitive performance. It is also used to flip the domains for extraction of bridge offset under changing temperature conditions.

Commonly owned U.S. Pat. No. 6,717,403, the disclosure of which is fully incorporated herein by reference, describes a set and offset system that is a suitable design for the present invention. Honeywell International Inc. has three AMR sensor families that include set/reset straps and the characteristics are as follows:

TABLE I

HMC100X family: (per bridge)
Set/Reset Strap Resistance: 1.5 to 1.8 ohms
Set/Reset Strap Current: 3.0 to 5.0 amps
Set/Reset Strap Ohmic Tempco: 0.37%/° C.
HMC102X family: (per bridge)
Set/Reset Strap Resistance: 5.5 to 9.0 ohms
Set/Reset Strap Current: 0.5 to 4.0 amps
Set/Reset Strap Ohmic Tempco: 0.37%/° C.
HMC105X family: (per two bridged)
Set/Reset Strap Resistance: 3.0 o 5.0 ohms
Set/Reset Strap Current: 0.4 to 4.0 amps
Set/Reset Strap Ohmic Tempco: 0.37%/° C.

Magnetic noise is common in the range of magnetic fields of interest to currency detection. Care must be taken to minimize the presence of moving magnetic materials in the transport mechanism. Field sensitivity from adjacent electronics and motors must be reduced or compensated for. By appropriately configuring the manufacture of the AMR elements, signal to noise ratios can be significantly reduced. Undesirable effects inherent in the sensor may interfere with magnetic field sensing such as bridge offset voltages and temperature effects. It is therefore desirable to perform automatic gain adjustment and real-time offset cancellation. By applying a strong magnetic field along the length of the sensor, performing the above described set/reset pulse, the alignment will always be maximized. Once aligned, the sensor will stay in that state for years unless a magnetic disturbing field is presented, which would be reason to again perform a set/reset pulse. The use of a set/reset pulse can also be used to reduce or eliminate offset voltage that may be caused if there is a resistor mismatch during manufacture.

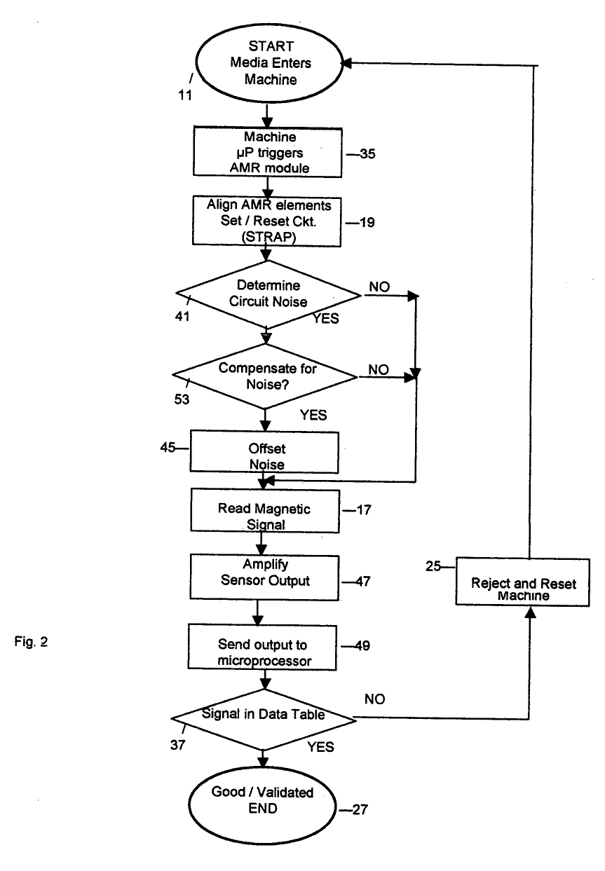

The present invention can be configured in a variety of ways. In FIG. 2, a trigger 35 is activated by the microprocessor 37, and an alignment element 39 aligns the document, subjects the sensor 17 to a set/reset sensor 19. A circuit noise detector 41 senses for noise and either uses a compensator 43, which in turn subjects the signal to an offset 45 to eliminate the noise or passes it directly to the sensor 17 which reads the magnetic signal. The output of sensor 17 is amplified by amplifier 47 and transmitted by circuit 49 to the microprocessor 37, where the signal is compared to a data source and either rejected by rejection device 25 or validated by validator 27.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. A device for validating a document having magnetic ink thereon, comprising:
an inlet for receiving a document having magnetic ink thereon;
a magnetic source for receiving said document and magnetizing said magnetic ink;
a media reader sensor positioned to receive said document having said signal thereon, said media reader sensor being spaced from said document by a predetermined gap;
a comparator positioned to receive said documents with a magnetic signal from said verifier, and compare the magnetic signal to a set of pre-existing data; and
a validator positioned to receive documents from said comparator and determine the existing of a signal to data match, said validator being adapted to reject signals that do not match any pre-existing data and validate documents that do have a match between the magnetic signal and pre-existing data.

2. The device of claim 1, which further includes a reader for determining the existence of said document in said device.

3. The device of claim 1, which further includes a set/reset sensor positioned to receive said document from said reader for applying a signal to said magnetic ink on said document.

4. The device of claim 1, which further includes a verifier for verifying the existence of a magnetic signal positioned to receive said document, said verifier being able to reject documents without a magnetic signal and pass documents with a magnetic signal within said device.

5. The device of claim 1 where said document is a currency note.

6. The device of claim 5, where said comparator is adapted to determine the value of said currency from said pre-existing data.

7. The device of claim 1, where said gap is from about 0.25 mm to about 1.5 mm.

8. The device of claim 7, where said gap is from about 0.5 mm to about 1.0 mm.

9. The device of claim 1, where said comparator is a microprocessor.

10. The device of claim 1, where said media reader sensor is an anisotropic magnetoresistive sensor.

11. A device for validating a document having magnetic ink thereon, comprising:
inlet means for receiving a document having magnetic ink thereon;
magnetic source means for receiving said document and magnetizing said magnetic ink;
a media reader sensor positioned to receive said document having said signal thereon, said media reader sensor being spaced from said document by a predetermined gap;
comparator means for comparing the magnetic signal to a set of pre-existing data and positioned to receive said documents with a magnetic signal from said verifier; and
validator means positioned to receive documents from said comparator for determining the existing of a signal to data match, said valiador means being adapted to reject signals that do not match any pre-existing data and validate documents that do have a match between the magnetic signal and pre-existing data.

12. The device of claim 11, which further includes reader means for determining the existence of said document in said device.

13. The device of claim 11, which further includes set/reset sensor means positioned to receive said document from said reader for applying a signal to said magnetic ink on said document.

14. The device of claim 11, which further includes verifier means for verifying the existence of a magnetic signal positioned to receive said document, said verifier means being able to reject documents without a magnetic signal and pass documents with a magnetic signal within said device.

15. The device of claim 11 where said document is a currency note.

16. The device of claim 15, where said comparator is adapted to determine the value of said currency from said pre-existing data.

17. The device of claim 11, where said gap is from about 0.25 mm to about 1.5 mm.

18. The device of claim 17, where said gap is from about 0.5 mm to about 1.0 mm.

19. The device of claim 11, where said comparator is a microprocessor.

20. The device of claim 11, where said media reader sensor is an anisotropic magnetoresistive sensor.

21. A method for validating a document having magnetic ink thereon, comprising the steps of:
passing said document first to a pre-magnetizer, followed by passage to a set/reset sensor, and thereafter to a media reader sensor spaced from said document by a predetermined gap;
verifying the existence of a magnetic signal and rejecting documents without a magnetic signal;
comparing the magnetic signal to a set of pre-existing data;
determining the existing of a signal to data match;
rejecting signals that do not match any pre-existing data; and
validating documents that do have a match between the magnetic signal and pre-existing data.

22. The method of claim 21, which further includes the step of determining the existence of a document having magnetic ink thereon at a specific location.

23. The method of claim 21, which further includes positioning a set/reset sensor to receive said document from said reader for applying a signal to said magnetic ink on said document

24. The method of claim 21 which further includes the step of verifying the existence of a magnetic signal positioned to receive said document, said verifier being able to reject documents without a magnetic signal and pass documents with a magnetic signal within said device.

25. The method of claim 21, wherein where said document is a currency note.

26. The method of claim 25, where said comparator is adapted to determine the value of said currency from said pre-existing data.

27. The method of claim 21, where said gap is from about 0.25 mm to about 1.5 mm.

28. The method of claim 21, where said gap is from about 0.5 mm to about 1.0 mm.

29. The method of claim 21, where said comparator is a microprocessor.

30. The method of claim 21, where said media reader sensor is an anisotropic magnetoresistive sensor.
